(19) United States
(12) Patent Application Publication
(10) Pub. No.: US 2006/0172029 A1
(43) Pub. Date: Aug. 3, 2006

(54) Magnetic industrial device

(76) Inventor: Patrick L. Farrell, Huntington Beach, CA (US)

Correspondence Address: WALTER A. HACKLER, Ph.D.;PATENT LAW OFFICE, 2372 S.E. BRISTOL STREET, SUITE B, NEWPORT BEACH, CA, 92660-0755, US

(21) Appl. No.: 11/046,156

(22) Filed: Jan. 28, 2005

(51) Int. Cl. A21C 7/00

(52) U.S. Cl. 425/208

(57) ABSTRACT

In a facility requiring transfer of a beverage during production thereof, the improvement includes a coupling apparatus passing bulk beverage therethrough and a having an outlet and an inlet along with a magnetic field generator associated with the coupling apparatus and exposing the beverage to the magnetic field as the beverage passes through the coupling.

The present invention is generally related to the industrial production of beverages and is more particularly directed to a magnetic coupling device, which provides an improvement in facilities requiring transfer of a beverage during the production thereof. Such beverages include wine, coffee, tea, fruit juices, vegetable juice, some beans, spirits, and chocolate.

In the production of these beverages, polyphenol, including tannins, and flavonoids are produced, which are thereafter extracted in a number of different procedures including, for example, maturation in oak.

The present apparatus is effective in reducing the bitterness and astringency caused by such treatment chemicals and the treatments for their removal.

Typically, these chemicals cause bitterness in many beverages and chemical changes may be induced by a strong magnetic field particularly in the presence of oxygen so that the bitterness and astringency are reduced and the beverage or food substance becomes richer and more flavorful. It is theorized that the magnetic field acts upon the charged polyphenols to induce polymerization, particularly in the presence of oxygen. Inasmuch as these changes can take place very rapidly, only a brief exposure to a magnetic field and oxygen is required.

Heretofore, a number of devices have been utilized to treat the end product beverage, more particularly bottled wine.

The production of various beverages obviously is effected through various processing stations, which vary in sequence and number depending upon the beverage being produced.

Even the type of wine necessitates a different sequence of processing stations. For example, high quality red wine grapes have a colorless juice and all of the red color is in the grape skins. Consequently, winemakers must leave the juice in contact with the skins for a period of time to extract the color.

Thus, red wine is made by crushing the grapes and then fermenting the juice, the pulp, and the skins, and the seeds together for variable periods of time. After this period of skin contact, or maceration, a wine press is used to separate the liquid from the solid materials.

On the other hand, white wine is made by a completely different process. First, the grapes are crushed and then usually pressed to immediately separate the juice from the solids. After pressing, the skins, stems, and seeds are discarded and the juice is cooled at a low temperature. The cold juice is then allowed to settle for several hours and the clear juice is decanted off the residue before it is fermented. White wine, therefore, is usually made by fermenting clarified juice. Sometimes, after crushing, the must is cooled and held in contact with the skins and seeds for a number of hours. The must is then pressed and fermentation begun.

In addition, fining is a process whereby positive or negatively charged substances (clay, synthetic chemicals, proteins) are added to the wine in order to bind the oppositely charged compounds (tannins and proteins), which then precipitate out of the solution.

Such fining materials are an expense in the wine making process. In addition, labor cost associated therewith increases the cost of the end product. Also, such fining processes can have negative impact upon the flavor of the wine.

Further, process stations include optional “micro-oxidation” in which small bubbles of oxygen are slowly added to red wine tanks so as to cause polymerization of the tannins. Even though such “micro” oxidations involves small amounts of oxygen, wines so treated can suffer from “oxidation”. A process which could stimulate tannin polymerization, while requiring less oxygen exposure, could represent an improvement in the winemaking process. Alternatively, a process, such as magnetic exposure of the wine during “micro-oxidation”, could lead to greater efficacy of the process in reducing either astringency or greenness of the wine, or other polyphenol containing beverage.

The present invention is directed to an improvement in facilities for the production of beverages, which may be utilized at any time a beverage is transferred from one process station to another.

### SUMMARY OF THE INVENTION

In accordance with the present invention, in a facility requiring transfer of a beverage during production thereof, the present invention provides the improvement which includes coupling apparatus passing bulk beverage therethrough and having an outlet and inlet. Alternatively, apparatus in accordance with the present invention may be affixed to existing equipment, such as a “micro-oxidation” device for use during the maturation of the beverage.

A magnetic field generator is associated with the coupling apparatus and exposes the beverage to the magnetic field as the beverage passes through coupling.

In one embodiment of the present invention, the beverage is red wine and the transfer occurs between at least two production stations selected from a group of stations consisting of crushing, fermenting, processing, clarifying, stabilizing, aging, and bottling stations with the coupling apparatus being disposed between the two selected production stations. If more than two production stations are selected multiple coupling apparatus in accordance with the present invention may be employed.

In another embodiment in which the facility produces a white wine and the transfer occurs between two production stations which are selected from a group consisting of crushing, pressing, settling, fermenting, clarifying, stabilizing, aging, and bottling, the coupling apparatus is disposed between the two selected production stations.

In addition, the coupling apparatus may further include an air inlet for introducing oxygen to the beverage passing therethrough.

In a facility utilizing a fining station with the fining station precipitating charge compounds, the coupling apparatus in accordance with the present invention may be beneficially disposed between the fining station and another station.

In a facility utilizing an oxidation station, the coupling apparatus in accordance with the present invention may be beneficially disposed between the oxidation channel and another production station, or may be fitted to the oxidation infuser.

In a facility in which the beverage produced is spirits, and the transfer occurs between at least two production stations selected from the group of stations consisting of storage, blending, and bottling stations, the coupling apparatus may be disposed between the two selected production stations. This would be of particular importance whereby wood barrels, wood staves, or wood chips were being utilized during the production process.

In facilities in which production stations are produced coffee and tea and include a group of stations including extraction, clarification, settling and bottling stations, the coupling apparatus in accordance with the present invention may be disposed between any of the two selected production stations or for the treatment of ground coffee beans or tea leaves prior to the extraction by hot water.

In a facility utilized for the production of fruit juice, with transfer occurring between at least two production stations selected from the group of stations consisting of squeezing settling, extraction, and bottling stations, the coupling apparatus in accordance with the present invention may be disposed between the two selected production stations.

In a facility in which chocolate is produced and transfer occurs between at least two production stations selected from a group of stations consisting of extraction, refining, melting, pouring, bottling, and molding stations, the present invention may be disposed between the two selected production stations. Alternatively, cocoa powder may be treated prior to heating.

In a facility in which the beverage is beer and transfer occurs between at least two production stations selected from a group of stations consisting of fermentation, blending, and bottling stations, the coupling apparatus in accordance with the present invention may be disposed between the two selected stations.

In addition, in accordance with the present invention, the magnetic field generator may comprise permanent magnets.

More particularly, a method in accordance with the present invention for improving the effectiveness of fining during the production of a wine includes adding fines to a wine to precipitate charged compounds, exposing the wine with added fines to a magnetic field, and thereafter filtering precipitated charged compounds.

Still more particularly, in accordance with the present invention, a method includes enhancing the effectiveness of oxidation during the production of wine which includes adding oxygen to a wine to polymerize the tannins and thereafter applying a magnetic field to the wine.

### BRIEF DESCRIPTION OF THE DRAWINGS

The present invention may be more clearly appreciated when taken in conjunction with the accompanying drawings, in which:

FIG. 1 is a plan view of a linear coupling in accordance with the present invention generally showing coupling flanges, an inlet and outlet along with permanent magnets attached thereto;

FIG. 2 is a plan view of another embodiment of a coupling in accordance with the present invention having a curvilinear shape and toroidal magnets disposed thereabout which may be permanent magnets or electromagnets;

FIG. 3 illustrates a union of the coupling shown in FIG. 1 or 2 with an outlet from a production stage;

FIG. 4 is a plan view of a clamp facilitating the union between a coupling and the production station illustrated in FIG. 3;

FIG. 5 is a schematic drawing of a facility including production stations for the production of red wine in which the present invention may be used to advantage;

FIG. 6 is a schematic drawing of a facility including production stations for the production of white wine in which the present advantage may be used to advantage;

FIG. 7 is a schematic drawing of a fining station which may be utilized in a facility shown in FIGS. 5 and 6;

FIG. 8 is a schematic diagram of an oxidation station which may be utilized in combination with the production facilities shown in FIGS. 5 and 6;

FIG. 9 is a schematic diagram of a facility for the production of spirits;

FIG. 10 is a schematic diagram of a facility for the production of coffee or tea;

FIG. 11 is a schematic diagram of a facility for production of fruit juices;

FIG. 12 is a schematic diagram of a facility including stations for the production of chocolate; and

FIG. 13 is a schematic diagram of a facility including production stations for the production of beer.

### DETAILED DESCRIPTION

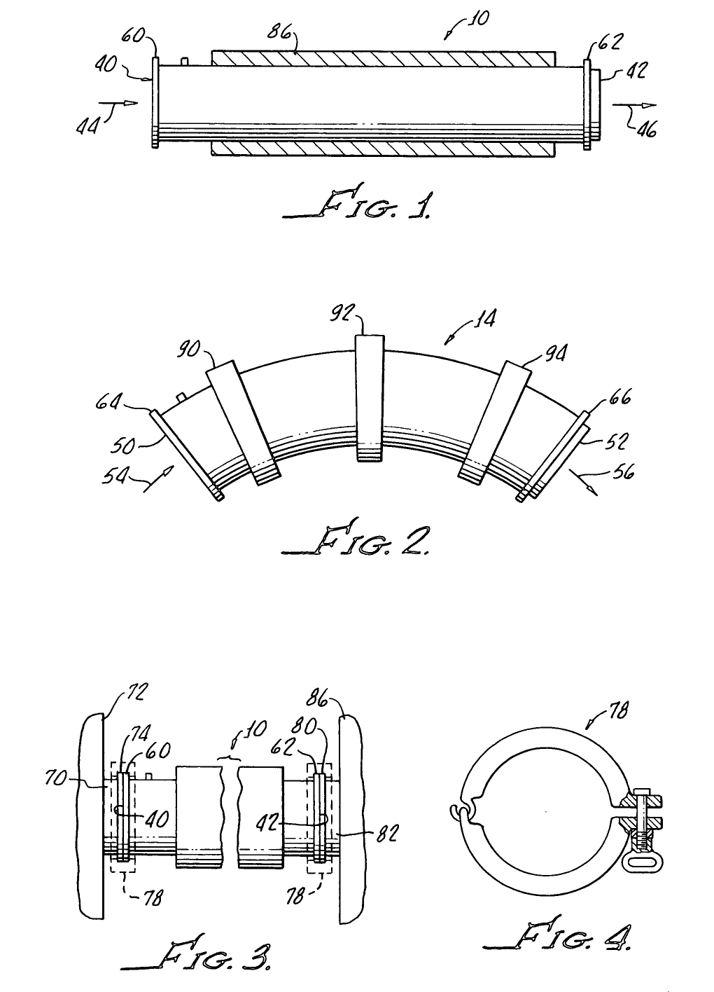

With reference to FIGS. 1 and 2, there is shown coupling apparatus 10, 14 suitable for use in facilities 20, 22, 24, 26, 28, 30, 32, 34, 36 respectively and diagramed in FIGS. 5-13 as will be hereinafter discussed in greater detail.

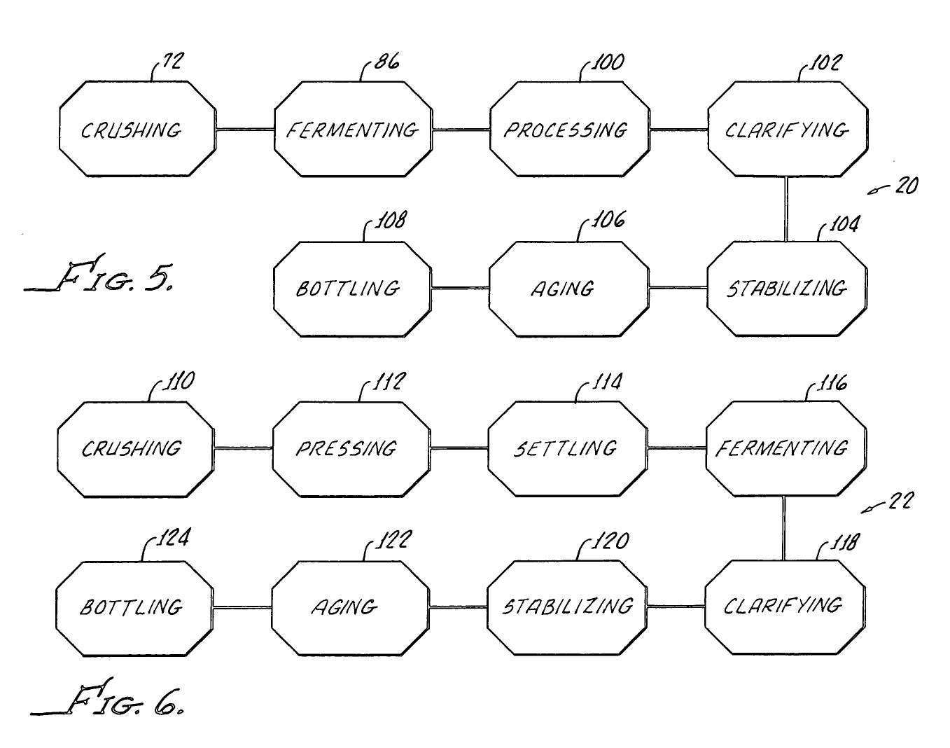

With reference again to FIGS. 1 and 2, as well as FIGS. 3 and 4, the coupling apparatus 10 includes an inlet 40 and an outlet 42 sized for enabling production quantities therethrough, as indicated by the arrows 44, 46.

Similarly, the coupling 14 includes an inlet 50 and an outlet 52 for enabling production quantities of beverage therethrough indicated by the arrows 54, 56. As shown in FIG. 2, the coupling 14 is curvilinear in shape as may be necessitated by or even by the various stations within the facilities 28-36, as hereinabove noted.

The couplings may be formed from any suitable material and may be rigid or flexible.

The couplings 10, 14 include conventional flanges 60, 62 and 64, 66 respectively to enable union with, for example, an outlet 70 of a crushing station 72 by abutment of the flange 60 with an outlet flange 74 through the use of a conventional clamping device 78, see also FIG. 4.

The outlet 42 may be interconnected by way of the flange 62 through the input flange 80 of an inlet 82 of a fermenting stage 86 of a red wine making facility 20, see FIGS. 3 and 5.

As shown in FIG. 1, a magnetic field generator 86 may be associated with the coupling apparatus 10 for exposing the beverage passing therethrough to the magnetic field, preferably the magnetic generator, are permanent magnets with linear magnets being shown in FIG. 1.

Alternatively, toroidal type magnets 90, 92, 94 may be utilized, as illustrated in FIG. 2 in combination with the curvilinear coupling apparatus 14.

The size and strength of the magnets may be adjusted depending upon the coupling diameter and facility 20-36 in which the couplings 10, 14 may be utilized.

In combination with the red wine production facility 20, shown in FIG. 5, the couplings 10, 14 may be utilized for transfer of beverage between typical production stations including crushing 72, fermenting 86, processing 100, clarifying 102, stabilizing 104, aging 106, and bottling 108. As hereinabove noted, the coupling 10, 12 may be utilized between one or more pairs of the stations 72, 86, 100, 102, 104, 106, 108.

For a white wine facility 22, as shown in FIG. 6, the coupling 10, 14 may be utilized between any two stations including the crushing station 110, pressing station 112, settling station 114, fermenting station 116, clarifying station 118, stabilizing station 120, aging station 122, and bottling station 124.

Other stations may be provided in any of the facilities 20, 36 and if utilized are to be considered within the scope of the present invention.

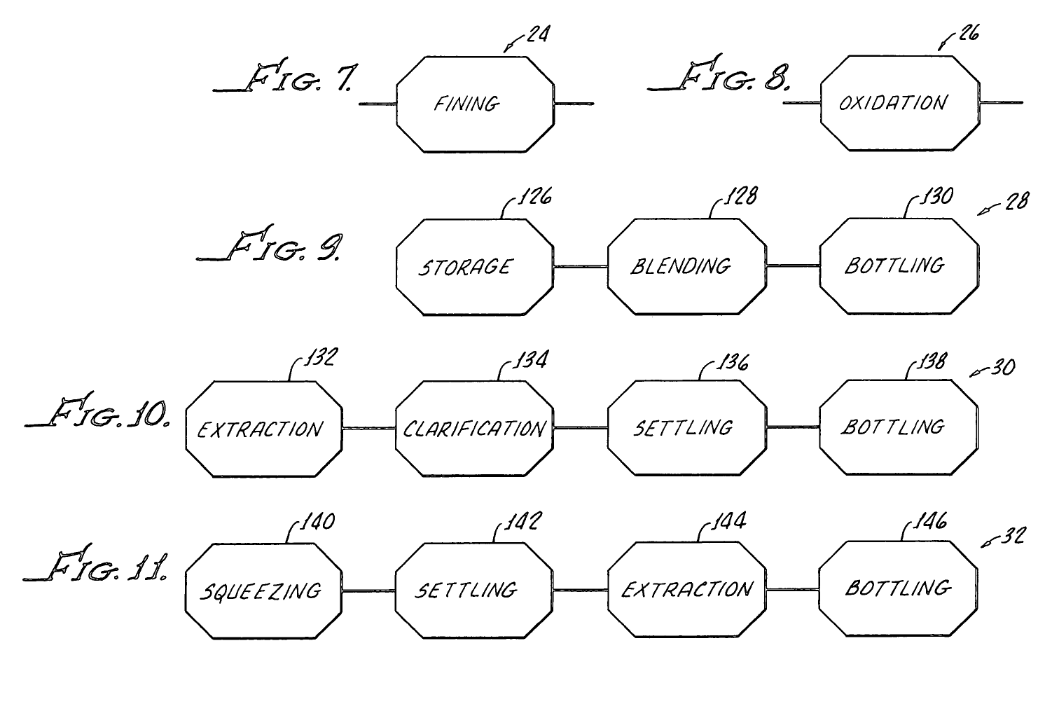

For example, fining station 24 shown in FIG. 7 or the oxidation station 26 shown in FIG. 8 may be used in combination with the red wine facility and the white wine facility 22.

With reference to FIG. 9, there is illustrated a facility 28 for the production of spirits which include a storage station 126, a blending station 128, and a bottling station 130, among others not shown, the coupling 10, 14 being utilized between any two stations as earlier illustrated in FIG. 3.

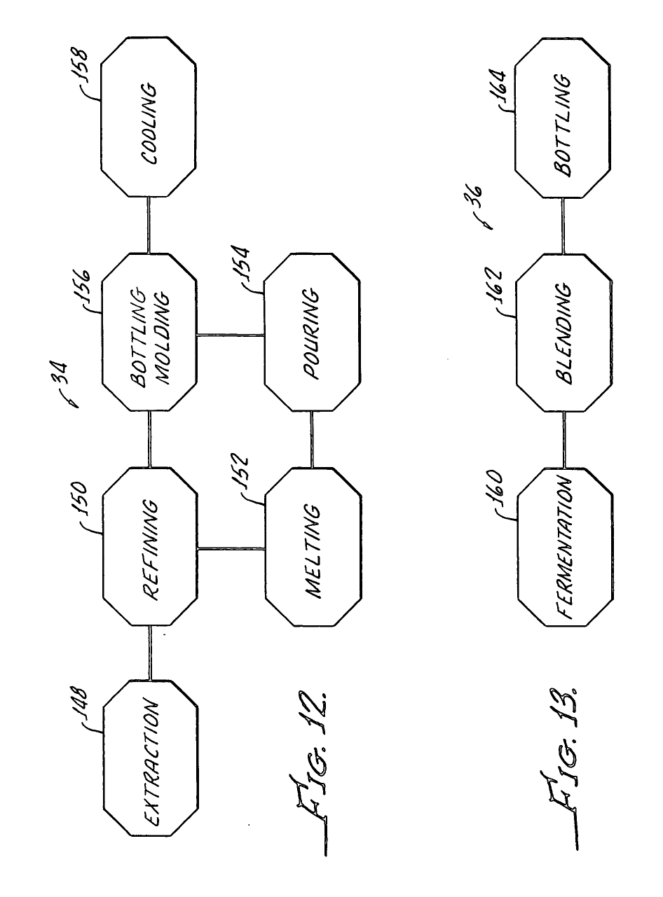

With reference to FIG. 10, there is shown a coffee and tea producing facility 30 which includes an extraction station 132, a clarification station 134, a settling station 136, and a bottling station 138, and perhaps others not shown, the coupling 10, 14 being disposed between any two stations as earlier illustrated in FIG. 3.

FIG. 11 illustrates a facility for the production of fruit juice and vegetable juice, which includes a squeezing station 140, a settling station 142, an extraction station 144, and a bottling station 146, the coupling 10, 14 being disposed between any two stations as earlier illustrated.

FIG. 12 is a diagram of a chocolate production facility 34, which may include an extraction station 148, a refining station 150, a melting station 152, a pouring station 154, a bottling station 156, and a cooling station 158, the coupling 10, 14 being disposed between any two stations as earlier illustrated in FIG. 3.

A beer production facility 36 is illustrated in FIG. 13, which may include a fermentation station 160, a blending station 162, and a bottling station 164 among others not shown but considered to be within the scope of the present invention, the coupling 10, 14 being disposed between any two stations as earlier illustrated in FIG. 3.

Although there has been hereinabove described a specific magnetic industrial device in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. In a facility requiring transfer of a beverage during production thereof the improvement comprising:
coupling apparatus passing bulk beverage therethrough and having an outlet and an inlet; and
a magnetic field generator associated with said coupling apparatus and exposing said beverage to said magnetic field as said beverage passes through said coupling.

2. The improvement according to claim 1 wherein the beverage is red wine and the transfer occurs between at least two production stations selected from a group of stations consisting of crushing, fermenting, processing, clarifying, stabilizing, aging, and bottling stations, said coupling apparatus being disposed between the two selected production stations.

3. The improvement according to claim 1 wherein the beverage is white wine and the transfer occurs between at least two production stations selected from a group of stations consisting of crushing, pressing, settling, fermenting, clarifying, stabilizing, aging, and bottling stations, said coupling apparatus being disposed between the two selected production stations.

4. The improvement according to claim 1 wherein said coupling apparatus further comprises an air inlet introducing oxygen to the beverage passing therethrough.

5. The improvement according to claim 2 wherein the transfer occurs between a fining station and another of the group of stations, said fining station precipitating charged compounds, said coupling apparatus being disposed between the fining station and the another station.

6. The improvement according to claim 3 wherein the transfer occurs between an oxidation station and another of the group of stations and said coupling apparatus is disposed between the oxidation station the another station.

7. The improvement according to claim 1 wherein the beverage is spirits and the transfer occurs between at least two production stations selected from a group of stations consisting of storage, blending, and bottling stations and said coupling apparatus is disposed between the two selected production stations.

8. The improvement according to claim 1 wherein the beverage is selected from a group consisting of coffee and tea and the transfer occurs between at least two production stations selected from a group of stations consisting of extraction, clarification, settling, and bottling stations and said coupling apparatus is disposed between the two selected production stations.

9. The improvement according to claim 1 wherein the beverage is selected from a group consisting of fruit juice and vegetable juice and the transfer occurs between at least two production station selected from a group of stations consisting of squeezing, settling, extraction, and bottling stations and said coupling apparatus is disposed between the two selected production stations.

10. The improvement according to claim 1 wherein the beverage is chocolate and the transfer occurs between at least two production station selected from a group of stations consisting of extraction, refining, and bottling stations and said coupling apparatus is disposed between the two selected production stations.

11. The improvement according to claim 1 wherein the beverage is beer and the transfer occurs between at least two production stations selected from a group of stations consisting of fermentation, blending, and bottling stations and said coupling apparatus is disposed between the two selected production stations.

12. The improvement according to claim 6 wherein said magnetic field generator comprises permanent magnets.

13. A method for enhancing the effectiveness of fining during production of wine, said method comprising:
adding fines to a wine to precipitate charged compounds;
exposing the wine with added fines to a magnetic field; and
filtering precipitated charged compounds from the wine with precipitated charged compounds.

14. The method according to claim 13 wherein the magnetic field is applied with permanent magnets.

15. A method for enhancing the effectiveness of oxidation during production of wine comprises:
adding oxygen to a wine to cause polymerization of tannins; and
applying a magnetic field to the wine.

16. The method according to claim 15 wherein the application of the magnetic field is done prior to the addition of oxygen to the wine.

17. The method according to claim 15 wherein the application of the magnetic field is done during addition of oxygen to the wine.

18. The method according to claim 15 wherein the application of the magnetic field is done after addition of oxygen to the wine.

19. The method according to claim 15 wherein the magnetic field is applied with permanent magnets.
